(19) United States
(12) Patent Application Publication
(10) Pub. No.: US 2020/0399736 A1
(43) Pub. Date: Dec. 24, 2020

(54) PROCESSES FOR PRODUCTION OF MICRONUTRIENTS FROM SPENT ALKALINE BATTERIES

(71) Applicant: TRACEGROW OY, KÄRSÄMÄKI (FI)

(72) Inventors: Mikko JOENSUU, Kalajoki (FI); Joni RAHUNEN, Vihanti (FI); Lasse RAUTIO, Oulu (FI)

(73) Assignee: TRACEGROW OY, KÄRSÄMÄKI (FI)

(21) Appl. No.: 16/961,542

(22) PCT Filed: Feb. 5, 2019
(86) PCT No.: PCT/FI2019/050085

§ 371 Date: Jul. 10, 2020

Related U.S. Application Data
(60) Provisional application No. 62/638,987, filed on Mar. 6, 2018.

(30) Foreign Application Priority Data
Feb. 5, 2018 (FI) 20185100

(51) Int. Cl. C22B 7/00; C22B 1/00; C22B 3/02; C22B 3/46; H01M 6/52; C05D 9/02

(52) U.S. Cl. CPC C22B 7/007; C22B 1/005; C05D 9/02; C22B 3/46; H01M 6/52; C22B 3/02

(57) ABSTRACT

A process for processing a leach solution of black mass of spent alkaline batteries which leach solution comprises metals dissolved to an acidic solution. The process comprises removing of one or more elements from the leach solution by a cementation operation by applying at least one non-noble metal in a metal form as a cementation agent and one or more additional cementation agents from both sulphate and nitrate groups to process the leach solution into a product of at least manganese- and zinc-containing sulphate solution which is suitable for use as micronutrients alone, in fertilizers and/or together with a plant protective agent to aid growth and health of plants. In addition, the invention also relates to a process for processing a black mass of spent alkaline batteries.

### CROSS-REFERENCE TO RELATED APPLICATIONS

This application is a U.S. National Stage of International Patent Application No: PCT/FI2019/050085 filed on Feb. 5, 2019, which claims benefit of Finland Patent Application No. FI 20185100 filed on Feb. 5, 2018 and U.S. Provisional Patent Application No. 62/638,987 filed on Mar. 6, 2018.

### TECHNICAL FIELD

The invention concerns a process for processing a leach solution of black mass of spent alkaline batteries.

### BACKGROUND THE OF INVENTION

Alkaline batteries make up about 80% of all collected spent batteries. Consequently, there is a need and interest of finding a process for recovery of metals used in spent alkaline batteries. Alkaline batteries are primarily batteries consisting mainly of zinc/zinc oxide and manganese dioxide (Zn/ZnO and MnO₂), thus being a multi-metal mix. In the alkaline battery, the anode (negative) is made of zinc powder, which gives more surface area for increased current, and the cathode (positive) is composed of manganese dioxide. In the alkaline battery cell (nominal voltage of a fresh alkaline cell is 1.5 V), there is an alkaline electrolyte of potassium hydroxide whereas zinc-carbon batteries have acidic electrolytes. In addition to the major substances stated above, heavy metals, such as nickel and copper, are also present in the alkaline batteries.

A prior art relating to the processing of spent alkaline batteries is exemplified by e.g. European patent application publication number EP 0620607 A1. It discloses a process in which spent batteries are crushed and the crushed particles are thereafter magnetically treated to separate ferrous material from Hg, Mn, Zn, Cd or Ni. Insoluble residues are then removed by a flotation process. The remaining solid residue is treated with a sulfuric acid solution adjusted to a pH of 2.5-4 to remove Hg. After removal of Hg, the remaining solution is further acidified by addition of more sulfuric acid. The solution is then subjected to electrolysis in which Zn is deposited on the cathode and Mn is deposited on the anode (which is thus the separation of the desired metals).

International patent application publication number WO 03021708, discloses a process in which used cells are crushed and magnetically separated, or are subjected to a thermal treatment, are then treated by alkalic attrition to remove any soluble salts (e.g. chlorides). The remaining solid is then leached by sulfuric acid under ultrasonication in presence of a reducing agent (such as e.g. hydrogen peroxide). From the resulting solution Hg is then removed by addition of 2,5-dimercaptothiadiazol or Zn powder). Thereafter heavy metals are removed by Zn cementation (Zn powder under hot thermal conditions). Finally, Zn and Mn are separated from basic or neutral salts (Mn as MnCO₃ and Zn as a Zn-ammonia complex).

An alternative route may be according to an article by Ferella et al., Journal of Power Sources 183 (2008) 805-811, suggesting a route where zinc is leached from crushed alkaline batteries using H₂SO₄ and the remaining carbon and manganese is roasted at 900° C. to produce manganese oxides and disposing the carbon residual as carbon dioxide. The zinc solution will contain zinc and sulfuric acid. The article suggests an electrowinning (or electroextraction) route for zinc.

Additionally, an international patent application publication number WO 2013/124399 A1 and European patent application publication number EP 1 148 571 B1 discloses yet some other methods to process alkaline black mass of spent alkaline batteries. In the latter the leach solution of the alkaline black mass is purified of heavy metals, except nickel, by means of cementation performed by using zinc as a cementation agent. Nickel is removed by complexation which complicates the process of removal of heavy metals. Also, an article by Sayilgan et al., A review of technologies for the recovery of metals from spent alkaline and zinc-carbon batteries, Hydrometallurgy, 2009, Vol. 97, p. 158-166, discloses the related technology.

Many known methods of recovering the metals used in spent alkaline batteries either use electrolysis or other methods to separate zinc and manganese from each other making them commercially less interesting. Consequently, there is a need for an efficient, cost effective and safe method for recovery of metals present in alkaline batteries. Therefore, there is an urgent need for an environmentally benign and techno-economically more feasible recycling technology. Particularly the removal efficiency of the heavy metal elements is low and the removing process is not cost-efficient.

### SUMMARY OF THE INVENTION

An object of this invention is to provide a process for processing a leach solution of black mass of spent alkaline batteries by cementation with a fast, simple, effective and also economical implementation. Another object of this invention is to provide a process for processing a black mass of spent alkaline batteries in which the process for processing a leach solution of black mass of spent alkaline batteries having the advantages stated above may be applied.

According to one embodiment of the invention, there is provided a process for processing a leach solution of black mass of spent alkaline batteries which leach solution comprises metals dissolved to an acidic solution and the process comprising removing of one or more elements from the leach solution by cementation operation by applying at least one non-noble metal in a metal form as a cementation agent and one or more additional cementation agents from both sulphate and nitrate groups to process the leach solution into a product of at least manganese- and zinc-containing sulphate solution which is suitable for use as micronutrients alone, in fertilizers and/or together with a plant protective agent to aid growth and health of plants.

According to another embodiment of the invention, there is provided a product of manganese- and zinc-containing sulphate solution wherein one or more harmful heavy metals are removed to an acceptable level in which the content of the harmful heavy metals are below the limits required for the product to be accepted as fertilizer product and which product is suitable for use as micronutrients alone, in fertilizers and/or together with a plant protective agent to aid growth and health of plants, and the product is obtainable by a process according to the invention.

According to another embodiment of the invention, there is provided a process for processing a black mass of spent alkaline batteries, comprising selectively pre-processing the alkaline black mass; leaching the selectively pre-processed alkaline black mass in an acidic solution to produce a leach solution; processing the leach solution to remove one or more heavy metals by cementation operation by applying at least one non-noble metal in a metal form and one or more additional cementation agents from both sulphate and nitrate groups as a cementation agents to process the leach solution into one or more products of at least manganese- and zinc-containing sulphate solution which is suitable for use as micronutrients alone, in fertilizers and/or together with a plant-protective agent to aid growth and health of plants.

According to another embodiment of the invention, there is provided a method to aid growth and health of plants comprising utilizing the product produced according to the invention for use as micronutrients alone, in fertilizers and/or together with a plant protective agent to aid growth and health of plants.

In the invention, according to one embodiment, one or more compounds including heavy metals are removed from the leach solution of black mass of spent alkaline batteries by means of the cementation operation by applying two or more cementation agents including at least one non-noble metal in metal form, such as, for example, zinc and/or manganese as a cementation agent, for example, powdered. In the cementation operation one or more typically harmful heavy metals, such as, for example, nickel being in the leach solution can be removed effectively to an acceptable level in order to use other substances being in the leach solution as a product of at least manganese- and zinc-containing sulphate solution which is suitable for use as micronutrients alone, in fertilizers and/or together with a plant protective agent to aid growth and health of plants.

Owing to the invention the leach solution of the black mass of spent alkaline batteries may be purified relative quickly and economically to such level that the content of the harmful heavy metals are below the limits that are required for the product to be accepted as fertilizer product. The purified MnZnSO₄-solution that may be the sellable product of the process may be used for micronutrients alone, in fertilizers and/or together with a plant protective agent to aid growth and health of plants. Thus, one particular advantage of the process is that it's unnecessary to separate zinc and manganese from each other, since both can be used in the same solution as micronutrient fertilizers, for example.

Owing to the process the removal of the heavy metal compounds is faster, simple and also more effective when compared to the prior art solution in which only zinc has been applied as a cementation agent and, for example, nickel has been removed by complexation. The leach solution of the black mass of spent alkaline batteries is a multi-metal solution which complicates the problem. The leach solution includes main metals, such as, zinc and manganese, which are desired to be left to the solution after the cementation operation and, in addition to these, also the heavy metals intended to be removed from the solution in the cementation operation. It has been observed that the removal of the heavy metals from the leach solution is a very slow operation by using only zinc (or other non-noble metal in metal form) as a cementation agent unless even essentially be possible at all, for example, particularly for nickel. By applying one or more additional cementation agent in addition to zinc (or corresponding non-noble metal in metal form) the cementation process progress faster, is effective for greater amount of substances (such as, for example, also nickel) and the process time is also reduced. Also the process devices are simple and the process may be run up very fast. Owing to the invention the recycled spent alkaline batteries may be effectively utilized as a fertilizer and thus reduce environmental load. Owing to the invention the spent batteries may be recycled very effectively. Other additional advantages achieved with the invention may be appreciated from the following detailed description considered in conjunction with the accompanying drawings.

### BRIEF DESCRIPTION OF THE DRAWINGS

The invention, which is not limited to the embodiments set forth below, is described in more detail by making reference to the appended drawings, in which

FIG. 1 shows a basic principle of the process and system according to the invention in a simplified flow chart,

FIG. 2 shows in greater detail an example of the stages of the process for pre-processing the alkaline black mass,

FIG. 3 shows in greater detail an example of the stages of the process for processing the alkaline black mass,

FIG. 4 shows a basic principle of the process and system according to the invention in a simplified process chart,

FIG. 5 shows another example of the basic principle of the process and system according to the invention in a simplified process chart including an implementation example of a purification stage,

FIG. 6a shows a table of test results comparing the first embodiment of the process according to the invention and the process according to the prior art and

FIG. 6b shows a table of test results comparing the second embodiment of the process according to the invention and the process according to the prior art.

### DETAILED DESCRIPTION OF THE INVENTION

Spent alkaline batteries are collected for the process of recovery of included metals. In generally, prior to any actions the spent batteries shall be sorted, since they contain both primary batteries (batteries that are discarded after their power deplete, for example, alkaline and zinc-carbon batteries) and secondary batteries (batteries that can be recharged, for example, Li-ion batteries and Ni-MH batteries). Such a sorting process has the aim of separating alkaline batteries from any other kinds of batteries such as, for example, re-chargeable lithium batteries and also trash in order to have alkaline batteries only as the starting material for preparation of the alkaline black mass BM. One sorting process that may be employed for this purpose is exemplified in WO 2011/113860 (A1). After the sorting the purity percentage concerning the alkaline batteries may be over 90%.

After sorting the alkaline batteries are crushed in a mechanical process in order to produce alkaline black mass (BM). Alkaline black mass, that is the starting material i.e. a raw material for the process, is produced in the recycling process of alkaline batteries. In the crushing the alkaline black mass has been produced, for example, through dismantling and magnetic separation of ferrous metals (like iron) prior to the leaching processes of the alkaline black mass.

The alkaline black mass BM powder is typically a mixture of the cathodic (manganese oxide and graphite) and the anodic (zinc oxides and electrolytic solution) materials including also minor amounts of heavy metals, such as, for example nickel and copper. In general, the alkaline black mass BM typically contains the following main metals; Al 1.2%, Fe 0.6%, Mn 30.0% and Zn 21.8% (vol %). However, it is to be clearly understood that any alkaline black mass can be the object of the processes according to the invention wherein the majority of metal content is, for example, mainly zinc and manganese. Thus, the present invention is mainly concerned with recovery of these main metals (content >10%) being present in the mixture or solution. The average particle size of alkaline black mass used in the process may be, for example <1.7 mm. Metals are known to be concentrated on the smaller fractions, and the more coarse fractions usually have more paper and plastic in them. Due to this reason these coarse fractions have been first sieved off to be processed separately, for example, with cyclones. However, the process presented herein is suitable of use on any particle sizes, and it is not mandatory to sieve the material.

In the process according to the invention it is beneficial to have a small particle size so as to speed up the reactions in the pre-processing of the alkaline black mass and/or in the leaching of the metals present in the pre-processed alkaline black mass 56 and/or and improve the efficiency of the removal of heavy metals. Even though, the alkaline black mass BM may be used as is, the process may also involve any technique resulting in a smaller particle size, such as e.g. grinding of the alkaline black mass BM prior to the pre-processing stages and/or leaching stage of the metals.

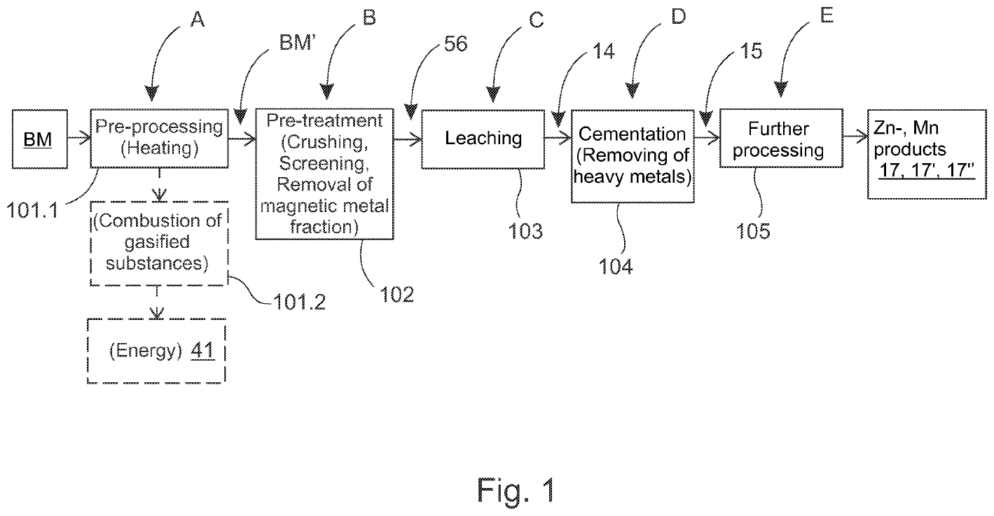

The alkaline black mass BM is subjected to different process stages to separate metals in the spent alkaline batteries. FIG. 1 shows a principle of the process, and also the system according to the invention as an example in a simplified flow chart. In that metals present, for example, in the alkaline black mass BM, or, in general, in a substance to be processed, is recovered by means of the following main stages: one or more optional pre-processing stages (A) and/or (B), leaching (C) of alkaline black mass BM, removal of one or more selected elements (i.e. purification of the leach solution of alkaline black mass BM) (D) and further processing of the purified leach solution to produce one or more micronutrient products 17 from the substances resulting from the stages of pre-processing and leaching of alkaline black mass BM and purification of the leach solution of the alkaline black mass BM (E).

In generally, the optional pre-processing stages A, B that are performed before the leaching C, includes, in the described embodiments, a heat treatment A, 101.1 of the alkaline black mass BM and after that a pre-treatment B of the heat treated alkaline black mass BM′. The pre-processing A performed by the heat treatment 101.1 may be used to reduce the alkalinity of the alkaline black mass BM, i.e lower its pH. In addition, for example, in the pre-processing being the heat treatment 101.1 has also been removed substances from the alkaline black mass BM. However, it must be emphasized that the black mass BM can be utilized as such without the heat treatment, or in general, the pre-processing corresponding the heat treatment. One another process of pre-processing corresponding to the heat treatment 101.1 is a washing operation of the alkaline black mass BM. Washing can be performed instead of the heat treatment 101.1 or in addition to that but, as with heat treatment, it is emphasized that the process works without this washing phase, as well.

In the case of heat treatment 101.1 as a pre-processing stage A, the pre-treatment stage B after the heat treatment A may include, for example, crushing, magnetic (iron) separation and possible grinding of the heat treated alkaline black mass BM′. In the case of washing as a pre-processing A at least some of these steps of stage B may also be performed already before the pre-processing stage A in order to remove any non-metallic coarse material present in the batteries, for example. These may be, for example, plastic films, paper pieces, electric wires etc. from the dismantling operation, non-woven cellulose or synthetic polymers. However, the material may also not be pre-treated in this sense any way before use or pre-processing stages, and hence the material may still contain plastic films, paper pieces, electric wires etc. from the dismantling operation. After crushing and possible other pre-treatment steps the hot alkaline black mass may optionally be put in bags and transferred to the cooling room. Cooled bags are then stored and ready for the next phase.

The pre-processing A, B of the alkaline black mass i.e. the heat treatment 101.1 and/or pre-treatment(s) 102 before and/or after the heat treatment 101.1 may be proceed as own independent processes that are not tied to the leaching process C, removal of the selected elements D from the leaching solution 14 or to the further processing E of the purified leach solution 15. In other words, between the pre-processing A, B and the leaching process C of the optionally pre-processed alkaline black mass 56 may be delay i.e. those need not to be continuous processes. This also means that the pre-processing A, B i.e. the heat treatment 101.1 and pre-treatment stages 102 may be performed another site than the leaching process C, removal of selected elements D and further processing E performed after the leaching process C and there may be, for example, transportation of the pre-processed alkaline black mass 56 from the pre-processing site to the leaching processing site.

In the leaching process C following the possible pre-processing A and pre-treatment B of the alkaline black mass BM 56 manganese and zinc shall be dissolved from it. Synonyms for leaching are, for example, dissolution and dissolving. In the leaching process C after the pre-processing A, B metals like, for example, manganese, zinc, potassium and heavy metals have been dissolved with one or more acidic solutions 12, 13, 25, 26 from the pre-processed alkaline black mass 56 in order to produce a leach solution 14. The leach solution 14 includes these metal element substances including manganese and zinc in acidic solution 25.

After the leaching stage C the leach solution 14 is then subjected to the purification stage D. In that the leach solution 14 is purified of one or more selected elements, such as, for example, heavy metals, like, for example, nickel and/or copper to produce a purified leach solution 15. In more generic level the purification stage D can also be defined as removal of one or more selected metals from the leach solution 14. Removal of one or more selected metals from the leach solution 14 is now performed by a cementation operation 104.

After purification stage D the purified leach solution 15 is then subjected to further processing E. Further processing E may also include one or more steps 105. These steps 105 may include, for example, adjustment of pH of the liquid residue of the purified leach solution 15, in generally, a neutralization step and also a clarification of the solution 15.

Finally, one or more products 17 have been obtained from the purified leach solution 15. These are, for example, manganese and zinc sulphate containing product 17 (or a raw-material for such) which is suitable for use as micronutrients alone, in fertilizers and/or together to aid growth and health of plants.

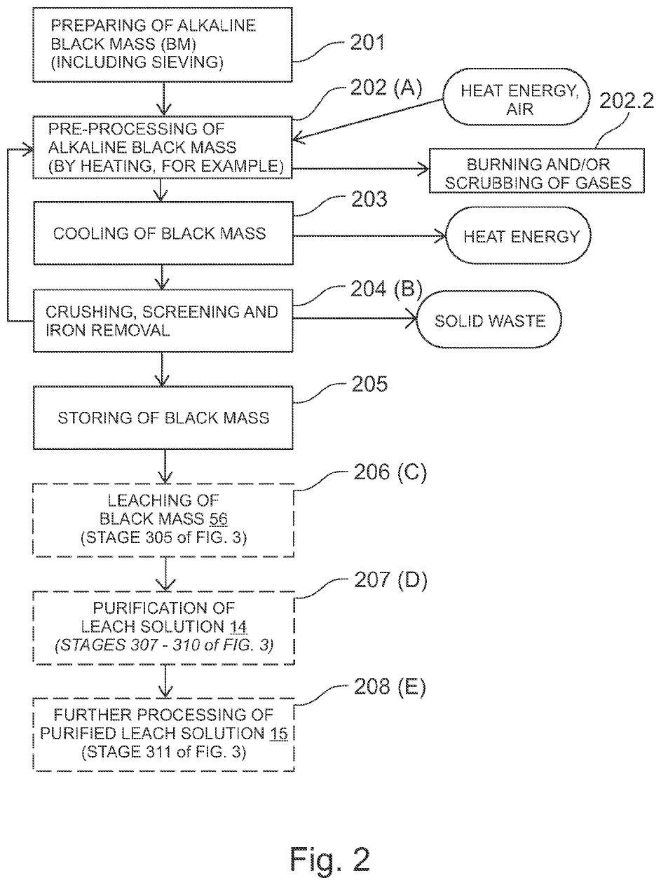

FIG. 2 shows in greater detail an example of the steps of the possible pre-processing A, B of the alkaline black mass BM of spent alkaline batteries. Here the purpose of the pre-processing A, B is to prepare the alkaline black mass BM for the leaching process C in order to recover one or more metals from the pre-processed black mass 56 in the leaching process C. Among others, in the pre-processing A the alkalinity of the alkaline black mass BM is reduced i.e. its pH is lowered from high alkalinity level (pH=13.5) towards neutral level. In the pre-treatment B the iron containing substances, or more generally, magnetic metal fraction, are removed from the heat treated alkaline black mass BM′. This has an advantageous effect, among others, to the purification stage D.

Preparing stage 201 of alkaline black mass BM may include, for example, particularly, if the heat treatment 101.1 is applied as a pre-processing A, sorting of collected spent batteries, dismantling and crushing of alkaline batteries, cooling of crushed alkaline batteries, removal of ferrous material from the crushed alkaline batteries and feeding of alkaline black mass to the pre-processing A. Owing to the preparing stage 201 it is possible to sieve the coarsest phases off from the alkaline black mass BM before the heat treatment 101.1 or any other possible pre-processing stage. This lessens the amount of flue gases and the use of energy in the heat treatment 101.1 and in general insoluble coarse material in the leaching stage C. It is, however, possible to insert the BM to heat treatment even without the sieving phase. In addition, the preparing stage 201 may include one or more storing steps between the other steps.

The pre-processing A of the alkaline black mass BM of spent alkaline batteries includes, for example, in the disclosed embodiment, a heat treatment of the alkaline black mass BM in step 202 after the preparing stage 201. Heat treatment 202 can be carried out, for example, in a furnace. Temperature of the alkaline black mass BM in the heat treatment 101.1, 202 is raised in the range 100-800° C. and more preferably in the range of 350-700° C., for example, about 600° C. The pH of the alkaline black mass BM in the beginning of the heat treatment 202 may be about pH=13.

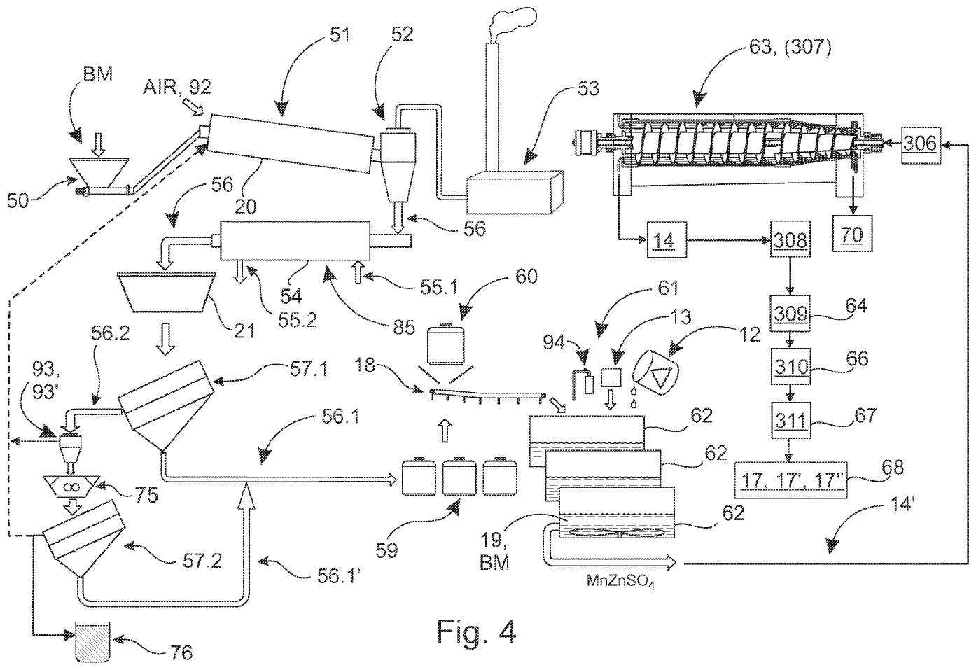

According to one embodiment the alkaline black mass BM is transferred to feeding silo (reference number 50 in FIG. 4), which feeds the alkaline black mass BM to the heat treatment 101.1. In generally, in the heating step 101.1 humidity, water ammonia, carbon, carbon dioxide, paper, board, and plastic components being in the alkaline black mass BM are removed from the alkaline black mass and, for example, burned on step 202.2. Owing to that these substances can be used in energy production on stage 101.2. Another option is the scrubbing of the gases arising in the heat treatment 202 and/or burning process of the gases. This may be done by using a gas scrubber to purify gases arising in the heat treatment 202. Owing to that the pre-treatment (for example, screening or sieving) of the alkaline black mass BM in order to remove any non-metallic material present in the batteries after the crushing may not be needed which also simplifies the process. In addition, the heat treatment 101.1 of alkaline black mass BM drops the alkalinity of the black mass and improves its homogeneity. In other words, the pH of the alkaline black mass BM is reduced in the heat treatment 101.1. Owing to the heat treatment 101.1 the amount of useless side flows, such as, plastic and paper shreds will be minimized.

By means of the heat treatment 101.1 as a pre-processing of the alkaline black mass BM is achieved an advantage, for example, in the dissolution of the alkaline black mass 56 i.e. in the leaching stage C. The leaching conditions between the untreated and heat-treated alkaline black mass BM are different (for example, the amount of water and acid), as well as the amounts of residual mass after the dissolution stage. The heat treatment 101.1 as a pre-processing A also speeds up the leaching reactions of zinc and manganese in the leaching process C. Owing to the heat treatment 101.1 zinc will be oxidized as zinc oxide. Zinc oxide leaches easily to sulfuric acid without forming great amounts of hydrogen gas.

Manganese in the alkaline black mass BM will occur in several oxidation states, but most commonly in +2 and +4. Oxidation state +4 will not be leached to sulfuric acid without a reducing agent in the leaching stage C. By means of conditions of the heat treatment 101.1 it is possible to influence to the composition of the final product(s) 17 and/or upgrading of the leach solution 14. Specifically, by means of conditions of the heat treatment 101.1 it is possible to change the formulation of the products relative to zinc and manganese. For example, one can manufacture a product which contains more zinc than manganese. After that from the residual sediment can be leached the manganese solution. Thus, the heating step 101.1 simplifies the process considerably in many different views.

After the possible pre-processing A, such as, for example, the heat treatment 202 the black mass BM′ is left to cool down by itself in stage 203, after which it is either put to the storage, or directly fed to the pre-treatment including screening in stage 204 and then stored in stage 205 and/or conveyed to the leaching process 206, (C) of pre-processed black mass 56 prior to the purification stage 207, (D) and further processing 208, (E). In the cooling stage 203 the heat energy of the black mass BM′ may be recovered. From the screening stage 204 solid coarse waste may be collected and the reject of the screening may be circulated back to the heat treatment stage 202. Screening stage 204 may also include crushing and magnetic separation (iron removal) from the heat treated alkaline black mass BM′. If the heat treatment 202 is not performed, the sieving of the coarsest phases is performed now. In this part of the process the coarsest phases, that mostly consist of carbon, paper, plastics and unwanted coarse metal particles are now removed. The part of black mass BM that goes through the sieving process is put through different mechanical and ferromagnetic separation phases, both of which remove unwanted particles from the mass itself. The process will enhance some features that are later essential in the purification process, for example. After these procedures the processed material 56 is transported to dissolution phase C.

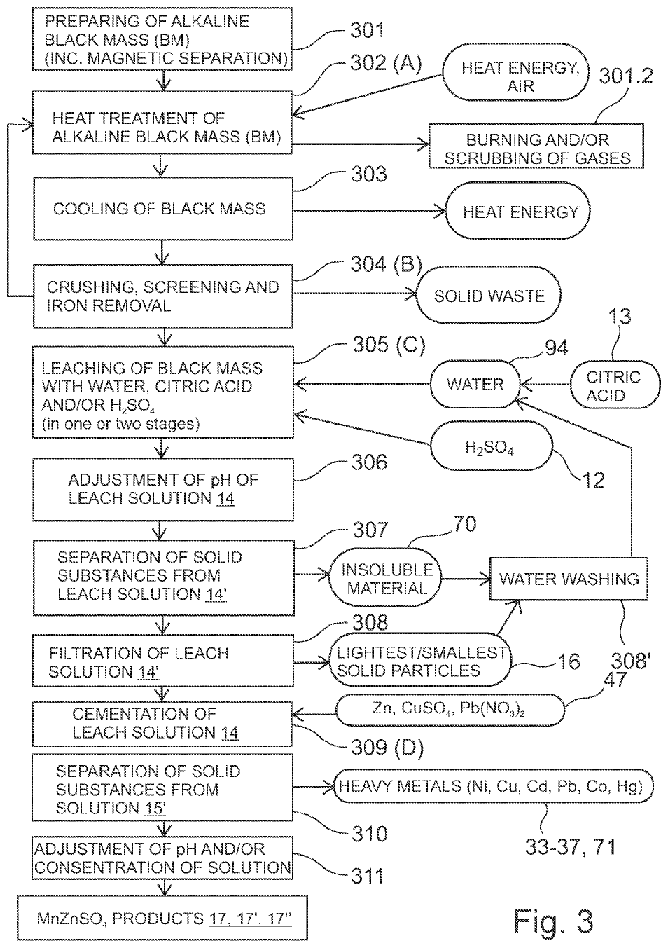

FIG. 3 shows in greater detail the stages of the process for processing the alkaline black mass BM of spent alkaline batteries. Stage 301 is preparing of alkaline black mass BM for the process. It may correspond the described and disclosed steps 201 of FIG. 2.

The alkaline black mass BM is again pre-processed A. The heat treatment stage 302 as a pre-processing A of the alkaline black mass BM may also correspond the stage 202 already described and disclosed in FIG. 2. The heat treatment 302 may be performed in oxidative conditions. One way to implement this is to feed air 92 to the heat treatment process 302.

The heat treatment 302 of the alkaline black mass BM may be performed in a reaction chamber, more generally, in a process device 51. The reaction chamber may be, for example, a furnace (or oven), a reel oven 20 or a heated screw. The reaction chamber may be, for example, a rotary type. In addition, the reaction chamber, more generally, the process device 51 in which the heat treatment process 101.1, 202, 302 of the alkaline black mass BM is performed may be indirectly heated. In that the alkaline black mass BM is not in direct contact with the heat source. In other words, for example in a furnace, the flames are not directed or contacted to the mass. Black mass BM mixing during the heat treatment 302 speeds up the process.

The residence time of the alkaline black mass BM in the heat treatment 302 may be 15-60 minutes, for example, 20-40 minutes. The residence time depends on, for example, the length of the process device 51. During the heat treatment 302 the humidity, ammonia, carbon, paper, board and plastic components, for example, are removed from the alkaline black mass BM. In addition, by the heat treatment 302 the alkalinity of the alkaline black mass BM is dropped. After the heat treatment 302 the processed black mass will be cooled in stage 303 and stored in the end of stage 304 for the next phase. Owing to the heating stage 302 the alkaline black mass BM may lose about 20-25% of its mass as burned and/or evaporated compounds.

The heat treatment 101.1 of the alkaline black mass BM may also be understood as black mass roasting. In other words, its purpose is not to burn the alkaline black mass BM, but to dry and oxidize it. In stage 302 the alkaline black mass BM is roasted in elevated temperatures in oxidative conditions. In addition, in stage 302 the alkaline black mass BM is roasted in elevated temperatures in air atmosphere. Oxidative conditions are achieved by feeding air to the furnace or to corresponding reaction chamber in which the alkaline black mass is under the heat treatment. In oxidative conditions the oxygen level in the furnace is kept high enough to maintain oxidation process (i.e. C->CO₂, Mn->MnO, Zn->ZnO, etc. . . . ) in the desired manner.

In the temperature ranges applied in the title invention the oxidative conditions have been achieved by feeding air 92 to the reaction chamber of the processing device 51. The cell reaction of the alkaline battery is Zn+2MnO₂ [symbol] ZnO+Mn₂O₃. In other words, the crushed alkaline black mass BM includes metallic zinc, zinc oxide and manganese at different oxidation states. Owing to the oxidative conditions i.e. by feeding air 92 to the reaction chamber next reaction equations will take place:

2Zn+O₂->2ZnO

MnO₂+2C->Mn+2CO

C+O₂->CO₂

This means that owing to the oxidative conditions the oxidized compounds of zinc and manganese are formed. This means that the dissolution phase shall be more effective, and one also avoids the melting (and evaporation) of metallic zinc, which would otherwise take place in carbothermic reduction without extra air feeding. Without feeding of the air 92 to the heat treatment the only source of the oxygen for the carbon would be the oxygen included in the metals. Owing to the oxidative conditions zinc will be oxidized to zinc oxide which leaches easily to sulfuric acid and does not form hydrogen at least in great amount.

Oxidation states of zinc and manganese can be altered by adjusting, for example, temperature and residence time. In the higher temperature the equilibrium part of manganese dioxide diminishes. In that case still larger part of manganese is in oxidation state +2, owing to which it leaches directly to sulfuric acid without reducing agent. This provides means for adjusting the zinc/manganese ratio of the final product 17 by means of the heat treatment 302. When producing final product with smaller manganese oxide ratio unleached MnO₂ sediment is achieved as a byproduct. That can be leached by means of reducing agent 26, for example, citric acid 13 to produce manganese-rich product 17″. In addition to the air also nitrogen may be fed to the heat treatment 302 in suitable ratios. Limiting the oxygen level may reduce the oxidation of manganese to manganese dioxide which is one way to effect to the zinc/manganese ratio of the final product. Other advantages of the heat treatment 302 are that paper, plastic and carbon contents are combusted during roasting reaction. These carbon containing substances may be used to produce additional energy 41 to the boiler system.

The alkaline black mass BM may be mixed during the heat treatment 302 in order to improve the oxidation reaction and mixing with the air 92. Some suitable heat chambers to implement this are the reel oven 20 and the heated screw. The oxidative reactions will be improved, and the reactions speeded up because the alkaline black mass BM mixes continuously with the air 92.

The black mass may be accepted to the leaching process C after most part of the ammonium, paper, plastic and board have been removed from the mass. Practically already at 150° C. with 1 hour reaction time about 15% loss of mass is achieved. Different heat treatment conditions however make it possible to adjust the ratios of the main metal components of the final product 17.

In stage 303 the resulting black mass from the heat treatment stage 302 may then be cooled. Cooling may take place, for example, in connection with a screw conveyer 54. In that the heat energy may be recovered, for example, to the district heating system (return water) 55.1, 55.2.

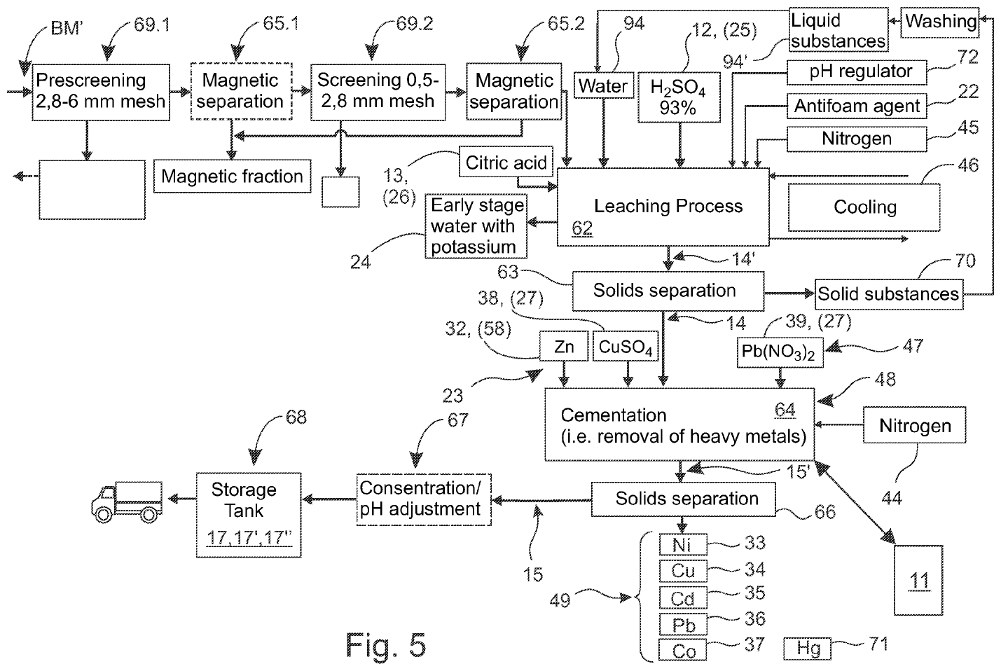

In stage 304 the black mass from the cooling stage 303 may then be crushed, screened and put through magnetic separation to remove the (nickel-plated) steel shred remains that originate from the battery walls (reference numbers 65.1, 65.2 in FIG. 5). Thus, the pre-processing B of the alkaline black mass BM includes a removal stage 102 of magnetic metal fraction from the alkaline black mass BM to be leached in order to reduce the amount of substance of elements 33 to be removed in the cementation operation 48 later on stage D. In other words, the pre-processed alkaline black mass BM′ may be pre-treated before the leaching process C. Screening 304 may include one or more stages, such as, for example, two-level screening (for example flat sieves 57.1, 57.2) and a crushing 75 between them. Heat treated and cooled black mass BM′ from the cooling 303 will be fed by conveyor, such as, for example, conveyer belt, to the first sieve 57.1 (FIG. 4) by which the most optimal size of the particle will be sorted for the leaching process C, 305 following the sieving. Size of the screen 57.1 may be, for example, 1.7 mm, although a bit larger mesh size can be used as well. Under size fraction of the heat treated black mass BM′ is accepted and transferred to leaching stage 305 by conveyor belt, for example.

To process over size fraction of the black mass 56.2 from the first screen 57.1 may have many different options. Over size fraction may be, for example, about 25% of the mass of the black mass 56. The oversize fraction may be first transferred to the separation 93 of the lightest fraction, such as, for example, papers, plastics. This may be done by cyclone 93′, for example. After that may follow an optional crushing 75 for size reduction. Crushing 75 may be performed, for example, in a ball mill or roll crusher. Before and/or after crusher can be optional magnetic separation for removal of magnetic fraction from the black mass. Magnetic fraction is thus removed from the process before leaching stage 305. After size reduction the crushed material may be fed to second level screen 57.2. Size of the second screen 57.2 may be also 1.7 mm. The undersize material 56.1′ may be fed to the leaching 305. The oversize material may be, for example, restored to the furnace, or more generally, to the heat treatment 302/processing device 51, if available, or returned to the beginning of the processing of the oversize material. This circulation may be performed continuously. Accumulating coarse material (mainly copper pins) 76 and also material from the separation 93 of the lightest fraction may be removed from the process.

After the screening stage 304 the undersize fraction of the black mass 56 is transferred to the leaching stage C, 305. Before the leaching C, 305 the black mass accepted to the stage may be analyzed. In other words, the pre-treatment of the black mass BM includes now also possible cooling and screening stages 303, 304 of the raw or heat treated alkaline black mass 56 between the optional heat treatment A, 302 and the leaching C, 305 as well as removal of magnetic material (such as, for example, iron) before the leaching stage C, 305.

The undersize fraction of the black mass 56 is lead to the leaching stage 305, (C). In other words, the pre-processed alkaline black mass 56 is leached C with one or more acidic solutions 12, 13 in order to produce a leach solution 14. In other words, it is also possible to speak out an acidic attack of the alkaline black mass 56. According to the embodiment the leaching has been made in an acid resistant tank (reference number 62 in FIG. 4) including screened and also optionally heat treated black mass with one or more acids 12, 13 (and possible water 94). In the disclosed embodiment the acids forming the acidic solution 25 are sulfuric acid 12 (H₂SO₄) as a leaching agent i.e. solvent in order to leach metals i.e. zinc and manganese and also optional citric acid 13. In this the citric acid 13 acts as an optional reducing agent 26. Other possible optional reducing agents 26 are, for example, oxalic acid, isocitric acid, and/or hydrogen peroxide. If a zinc-rich solution 17′ is wanted, only sulfuric acid 12, i.e. strong leaching agent 25 is used to leave as much manganese in solid form and as much zinc in liquid form as possible.

In the disclosed embodiment the leaching process C, 305 is performed now in a single stage process i.e. as a batch. The leaching C can be performed as a batch process performed in one leaching tank 62. Batch volume may be, for example, 10 m³ to 30 m³. The pre-processed alkaline black mass 56 is now leached in the presence of the reducing agent 26, water 94 and sulfuric acid 12. As a first stage in the leaching C, 305 may be added computational amount of fresh water 94 into the reactor 62 (FIG. 4). The necessary amount of water to be added to the reactor 62 depends on the pre-processing of the alkaline black mass BM. The amount of dissolved metals can be controlled with the water amount. Water acts here as a matrix solution in which the reactions take place. Water dilutes the solution and acids therein and makes possible the mixing and movement of the black mass BM during the leaching C. It is also possible to speak out an aqueous acidic solution 19.

After that or with the water 94, citric acid 13 can be added to the reactor 62. The citric acid 13, if considered necessary, acts now as reducing agent 26 to manganese. The amount of citric acid 13 depends on the features wished for the final leach solution 14. Citric acid 13 reduces Mn⁴⁺ to Mn²⁺-form, after which most of the manganese shall end up to the sulphate form in the liquid 14. In addition, one mole of citric acid may reduce nine moles of manganese which makes citric acid very effective in this connection. The citric acid 13 may be in solid form. The concentration of the citric acid 13 may be in the range of about 3 to 6 M. After the water 94 (and possible citric acid 13) additions the pre-processed and pre-treated alkaline black mass 56 is added to the reactor 62. Use of nitrogen atmosphere (reference number 45 in FIG. 5) in the filled-up reactor 62 is necessary, because during the reaction some hydrogen is formed, which is potentially explosive when it has contact with oxygen.

After the creation of nitrogen atmosphere the leaching process C, 305 is continued by adding a second leaching agent to the leaching process C. This may be done in the same reactor 62 i.e. to continue by adding to the existing leaching process C second leaching agent 12. Second leaching agent is now sulfuric acid 12. This acid addition is continued until the pH is stabilized to ≤1.7, for example, to 1.0 or 1.2, depending which level is seemed to be suitable for the product that is created at the current moment. Because this reaction is exothermic, the temperature raises and the reactor 62 is cooled by cooling means 46 during the leaching process to keep the temperature under 100° C. There is no need for additional heating as temperature raises due to release of chemical energy. Optimum leaching process takes place in between 70-90° C. Temperature in leaching reactors 62 can be controlled by circulating cold water or water vapour in heat exchange jacket. The formation of hydrogen and especially carbon dioxide will cause foaming, and this can be kept under control by using anti-foaming agent 22 (for example, DST antifoam including an- and non-ionic surface-active agents) or ultrasonic antifoaming equipment, if necessary. The reaction time during the leaching process C may be in the range of any time to completely or almost completely dissolve the metals of the pre-processed alkaline black mass 56. Such time ranges may be in the range of 2-5 hours, although longer dissolution times can be used as well.

In the leaching process C is performed the leaching of metals that remain in the pre-processed alkaline black mass BM: manganese, zinc, nickel, copper (and also iron). In the disclosed embodiment zinc and manganese dissolve in the leaching stage C, 305 according to following equations:

MnO+H₂SO₄→MnSO₄+H₂O

Mn₂O₃+H₂SO₄→MnO₂MnSO₄+H₂O

Mn₃O₄+2H₂SO₄→MnO₂+2MnSO₄+H₂O

ZnO+H₂SO₄→ZnSO₄+H₂O

Zn+H₂SO₄→ZnSO₄+H₂

The pre-processed alkaline black mass 56 contains manganese (IV) oxide (in the form of MnO₂). Therefore, a reducing agent 26 may be used in order to achieve complete dissolution of main metals (zinc and manganese), and also to reduce any insoluble metal oxides formed by reaction of the acid (such as e.g. sulfuric acid). Alkaline black mass contains also some other oxidized compounds of manganese, such as Mn₂O₃ and Mn₃O₄. These compounds are only slightly soluble and can form more MnO₂ to the process. An example of an appropriate reducing agent 26 to be used in this step is, for example, citric acid 13. Reducing leaching of manganese oxide in the solution of sulfuric acid 12 and citric acid 13 is given by the following equation:

9MnO₂+9H₂SO₄+C₆H₈O₇→9MnSO₄+13H₂O+6CO₂

The reductive leaching leads to the dissolution of metals from the pre-processed alkaline black mass 56. pH of the heat treated alkaline black mass 56 to be leached may be about in the range of pH=7 to pH=9, for example, or below pH=7. In other words, the pre-processing A, i.e. the heat treatment process 202, 302 drops the pH of the alkaline black mass BM down from the original level, which is about pH=13.5. Owing to this the amount of acids 12, 13 needed in the leaching process C is less, although it is once again emphasized that the heat treatment phase 101.1, 202, 302 is not mandatory for the process, and it can be driven without heat treatment as well. pH in the leaching stage 305 after acid additions including the leaching solution 12, 13 may be, for example, in the range of pH=1.0-1.7. By means of the leaching manganese and zinc have been changed to sulfate form from oxide and possible metal forms. Liquid/solid ratio at the beginning of the leaching for leaching agent 12 may depend on the size of the reactor 62. The concentration of the leaching agent 12 may be in the range of 15-20 M and more particularly, in the range of 16-18 M and for the reducing agent 26 in the range of 3-7 M and more particularly, in the range of 4-6 M. In the leaching the metals being still in the pre-processed alkaline black mass 56 are leached to the leach solution 14 being the result of the leaching stage 305. The amounts of the leaching chemicals are defined so, that the amount of water 94 may be, for example, 2.0-3.5, the amount of sulfuric acid 12 may be, for example, 0.80-1.1 and the amount of citric acid 13 may be, for example, 0.05-0.15 times of the mass of black mass BM that's used in the process.

The pH in the leaching process C, 305 is monitored. When the pH stabilizes the reaction is finished. After the leaching process C, 305 the leach solution 14′ can be artificially cooled down, for example, to 50° C., if that is necessary for the next phase, for example. This can be performed by means of cooling jacket built in the reactor 62, for example. The heat energy obtained from the cooling 46 may also be recovered.

At the completion of the leaching process C, almost the entire metal content of the alkaline black mass BM is in solution 14 due to the acidic attack in the leaching process C. It is to be clearly understood that of the metals present in the alkaline black mass, the dissolution percentages between the different metals may vary such that e.g. 85% of one metal may be in solution and 95% of another metal may be in solution after completion of the leaching process C.

According to another embodiment, the leaching process C, 305 may also be performed in such a way, that in the first stage only sulfuric acid 12 is used as a leaching agent. Owing to this the solution 17′ shall become zinc-rich, because more manganese shall stay in the solid form. After this first leaching stage the liquid-solid separation shall be performed, and the residue of the solid substances can then be leached again but now by combination of sulfuric acid 12 and citric acid 13. Owing to this the leach solution 17″ of the second leaching stage shall be manganese-rich solution. This embodiment is independent of, for example, the pre-processing A, such as, for example, heat treatment 101.1 and also of the implementation of the purification method D.

Yet, according to one embodiment, when applying single stage leaching C, 305 disclosed already above, about 10-30% of the intended total amount of water can be fed to the reactor 62 first, after which the formed slurry may be mixed for a while, for example, 20-60 minutes. In other words, this “washing” may be done in the beginning period of the leaching process, for example, in the first half of that. After this the slurry is left unmixed for a while for the solids to settle down, and some of the water inside the reactor 62 (for example, 20-50% of it) may be sucked away. After this the removed water shall be filtered and treated with sulfuric acid 12, if this is deemed to be necessary. Finally, the reactor 62 shall now be filled with fresh water 94 in such a way, that the original total amount of water shall be reached in the reactor 62. Owing to this the potassium content of the solution 14 may be lowered, also in the leaching process C, 305, and a new potassium-rich product 24 is formed. In addition, this also raises the relative zinc and manganese content of the solution 14. Too high potassium content may cause problems, since it forms more easily crystals with zinc. Yet however, the leaching phase can be driven without this potassium-water removal phase as well.

After leaching 305, (C) and also the cooling, pH of the leach solution 14 i.e. the mix of leached black mass and one or more acids 12, 13 with the leached substances may be adjusted (i.e. neutralized) at stage 306. The neutralization is now performed by adding the neutralization chemical straight to the mass solution 14′. Strong bases (for example, NaOH) may be used for this, although the neutralization can be driven by other means as well (for example, by addition of solid ZnO). If strong bases are used, they shall also precipitate all the dissolved iron away as iron hydroxide, which shall then exit the solution with the removal of the residual mass from the solution. One can also do the neutralization phase to the clear liquid when the residual mass is first removed, but since the hydroxide solids are extremely hard to be filtered away because of their small grain size, neutralization is preferred to be done before the residual mass removal.

Depending of the implementation of the leaching process C the neutralization step 306 may also be optional. In the adjustment stage 306 pH of the leach solution 14′ is adjusted to the range of pH=2 to pH=4, more particularly, pH may be between 3.0 to 3.3. pH level depends on product chosen to be processed. According to one embodiment in the adjustment of pH it is possible to use NaOH or KOH, for example. Usually the pH adjustment is done by using NaOH or KOH. To keep both the Zn and Mn in the solution, too high pH is avoided since the metals can start to precipitate out of the solution. Sometimes, however, this normally harmful feature may actually be utilized in another kind of application. In this case pH is lifted to high levels, such as, for example, pH=7 to 8, intentionally, after which the zinc starts to precipitate off as hydroxide leaving a manganese-rich solution, which may be marketed to some customers as such.

In addition, if it is desired to leave some iron to the solution 14′ and/or the pH is desired to be of lower value, it is also possible to make the neutralization in a lighter manner depending on the wishes of the customer. After the neutralization the nitrogen atmosphere is again created to the reactor 62, after which the residual mass including iron containing residue is removed from the solution 14′. In other words, before the cementation operation 48, 104, 207, 309, the pH of the leach solution 14 is adjusted at stage 306 with the solid substances 16, 70 which are, after pH adjustment stage 306, separated in one or more stages 307, 308 from the leach solution 14′ before the cementation operation 48, 104, 207, 309.

The separation and filtration stages 307 and 308 are then performed after the neutralization stage 306. In those, the residual mass 16, 70 is taken away from the leach solution 14′. The leach solution 14′ is separated from the solid insoluble substances at stage 307. In that the solid residue 70 from the leach solution 14′ is separated. According to the embodiment this may be performed by means of a factory-sized decanter centrifuge 63 by which insoluble material 70 is separated or some other apparatus that is suitable for the removal of solids. The amount of insoluble material 70 may be about 10-25% (w/w) from the pre-processed alkaline black mass 56 which was fed in to the leaching tank 62. One example of the separator is a decanter 63 marketed by Alfa Laval's in the name of P2-305. The separation stage 307 removes from the solution 14′ mainly carbon related substances and possible other insoluble materials 70. This remaining material 70 (mostly organic carbon and graphite from the batteries) after the reductive leaching C can be utilized in the energy production, e.g. by combustion.

The separated solution 14′ from stage 307 will continue from the decanter centrifuge 63 through a separate filter (not disclosed) to eliminate the lightest and the smallest solid particles and substances 70, 16 (mainly carbon) from the acidic liquid. This filtering takes place in stage 308. After removing the solid substance 70, 16 the solution 14 may be transferred to storage tanks. The separation-filtering procedure totality may also be implemented in a one process, i.e., without separate separation and filtering sub-stages 307, 308.

The insoluble material 70 from stage 307 (for example, from the decanter 63) and/or also the solid particles from stage 308 (carbon separation) can be washed at stage 308′ with hot water. Owing to this the metal content of the leach solution 14 bound to the carbon of the separated solid sediments 70, 16 can be separated from the solids to liquid phase, in this case washing water. Owing to this the sediments lighten about 50-70%. In addition, the waters used to the washing at stage 308′ that are separated from the washed solid substances can then be returned to the process by using washing water to the leaching in the next leaching batch with the tap water. This provides better yield. In other words, before the cementation operation 48, 104, 207, 309 the solid substances 16, 70 separated from the leach solution 14′ are washed 308′ with water which washing water is then returned back to the leaching process C, 103, 206, 305. The solid residue can be utilized in the energy production, e.g. by combustion, for example.

The filtrate i.e. the separated and filtered leach solution 14 i.e. the liquid residue of the leach solution 14′ from the filtration stage 308 may then be lead straight to the reactor 64 for purification process D or some storage tank, after which a sample from the leach solution 14 may be taken. After the filtration stage 308 pH of the solution 14 may be in the range of pH=0.5 to pH=1.2. The sample is analyzed to determine the amount of different metals in the leach solution 14, and how much something needs to be removed.

In the purification stage 309 the liquid i.e. the leach solution 14 of alkaline black mass is led to the purification reactor 64 (FIG. 5). The volume of the reactor 64 may be, for example, 3 m³. A reference is now made to the FIG. 5 which shows another example of the basic principle of the process and system according to the invention in a simplified process chart including an implementation example of a purification stage 309, (D). In this embodiment has been described two optional pre-screenings 69.1, 69.2 between which magnetic separation 65.1 or other corresponding mechanical method, such as, gravitation based method, is applied to reduce the amount of iron and corresponding magnetic material from the black mass BM′. Instead of or in addition to the first magnetic separation 65.1 being between the screenings 69.1, 69.2 there may be magnetic separation 65.2 just before the leaching process, i.e. between the final screening stage 69.2 and the leaching tank 62. One or more pre-screening stages may be present or, alternatively, there may not be pre-screening and/or magnetic separation(s) 65.1, 65.2 at all. The first pre-screening 69.1 has been performed with 2.8-6 mm mesh and the second pre-screening 69.2 has been performed with 0.5-2.8 mm mesh, for example. In connection with the leaching tank 62 has now been presented the input of pH regulator 72, such as, for example, NaOH or some other suitable substance.

The purification stage 309, (D) according to the invention is to be understood as a process for processing a leach solution 14 that may be performed independently and separately of the other stages of the process. The leach solution 14 to be processed by the process is originated from leach process of black mass of spent alkaline batteries. The leach solution 14 includes one or more metals, such as, for example, at least zinc, manganese and also heavy metals, dissolved to an acidic solution. In the processing one or more elements 49 are removed 309, (D) from the leach solution 14 by cementation operation 48, 104, 207, 309. In other words, the leach solution 14 is purified of the elements 49 by the cementation operation 48 including the removing of heavy metal containing substances 33-37, 71 from the leach solution 14. Regardless of the sorting of collected spent batteries for recycling the alkaline black mass BM always contains heavy metals originated from other battery types than only alkaline batteries. These heavy metals may be copper, cadmium, lead, cobalt, mercury and nickel which may also be originated from the alkaline batteries itself. Thus, the alkaline black mass BM is typically originated from a joint collection points of spent batteries. In that kind of recycling the batteries have been collected in a recycling points in which all kind of batteries have been put to the common box independently of their type.

In the cementation has been applied at least one non-noble metal 58 in metal form as a cementation agent 47. One example of this is zinc. Another example of this may be iron or manganese, particularly, in the case in which manganese-rich solution 17″ is the desired final product.

In the purification process 309, (D) also one or more additional cementation agents 27 are applied in the cementation operation 48, 104, 207, 309 in addition to at least one non-noble metal 58 in metal form, such as, zinc 32. This is done in order to process the leach solution 14 into a product 17 of at least manganese- and zinc-containing sulphate solution which is suitable for use as micronutrients alone, in fertilizers and/or together with a plant protective agent to aid growth and health of plants. This, i.e., the additional cementation agent(s) 27 enhance the purification process 309, (D) i.e. the cementation operation 48 and particularly speed it up in a considerable way when compared, for example, to the cementation performed using only zinc 32 or some other non-noble metal 58 in metal form as a cementation agent 47.

The leach solution 14 to be processed is now a multi-metal solution. In the described embodiment the multi-metal solution includes one or more metals selected from the group which includes zinc, manganese and potassium. In addition, the multi-metal solution includes now one or more heavy metals selected from the group which includes nickel and copper. The elements 49 to be removed from the leach solution 14 include or are one or more of the heavy metals being present, for example, as compounds, in the multi-metal solution. The additional cementation agent(s) 27 improves and speed up particularly the removal of the selected elements 49 in the case of multi-metal solution.

One or more additional cementation agents 27 include surprisingly one or more elements including heavy metals. More particular, according to one embodiment one or more additional cementation agents 27 include one or more heavy metals selected from the group which include copper and lead. According to one specific embodiment one or more additional cementation agents 27 are in one or more forms selected from the group which includes a sulphate and a nitrate. This is advantageous when considering the final use of the product(s) 17, 17′, 17″ (i.e, plants). In this case some examples of the additional cementation agents 27 are copper sulphate 38 and lead nitrate 39. Thus, according to one embodiment at least some of one or more additional cementation agents 27 may include also heavy metal (for example, copper) intended to be removed from the leach solution 14 to be processed. In the pilot stage tests have been observed that these agents, for example, having heavy metals accelerate or even make possible the cementation operation of the elements 49 to be removed from the leach solution 14 relative to the only zinc 32 or other non-noble metal 58 in metal form used as a cementation agent 47. The cementation is based on the application of the galvanic series (or electropotential series) of the metals in which the oxidation-reduction reactions (electron transfer) take place between the substances in a certain manner by cementing the elements based on their electropotential. Synonym for the cementation may be, for example, precipitation.

Lead is added as lead nitrate 39, which is in liquid form. It reacts with the sulfate matrix of the solution 14 forming solid lead sulfate, but it shall stay in extremely small particle size that enables it to react better in the cementation operation. The nitrate ion that is loosened in the reaction is practical, because nitrates are readily used in fertilizer products and so it's presence is not a problem.

Zinc 32 as the cementation agent 47 or other non-noble metal 58 in metal form may be in the form of a powder or dust. The additional cementation agents 27 may be in the form of solids and/or solutions, for example. The copper sulphate 38, for example, may be in a solid form. When the main element that must be removed from the leach solution 14 is, for example, nickel 33, proper amounts of copper sulphate 38, lead nitrate 39 and zinc powder 32 of proper mesh size may be determined on the basis of that. Thus, also the mesh size of the zinc powder may be advantageously established on the basis of the heavy metal intended to be removed from the leach solution 14 to be processed.

Total amounts of substance of copper sulphate 38 and lead nitrate 39 may be 2-8 times of the amount of substance of nickel being present in the leach solution 14 to be processed. Thus, the amounts of substance of the two chemicals 38 and 39 are calculated according to the amount of substance of nickel present in the leach solution 14 in such a way, that the total amount of substance of these added cementation agent metals is 2-8 times higher compared to the amount of substance of nickel. According to the process the amount of substance of nickel may be affected already in the pre-processing stage B. The pre-processing B of the alkaline black mass BM may include a removal of iron 102 or corresponding magnetic material from the alkaline black mass BM to be leached in order to reduce the amount of substance of elements 33 to be removed from the leach solution 14 in the cementation operation 48. One of these is nickel, because nickel is usually bound to the nickel-plated steel shreds which are ferromagnetic, and thus it is possible to remove them with magnet in the pre-processing B stage. The amount of cadmium may be lowered as well, because some of it may be stuck on nickel shreds that originate from NiCd-batteries.

If necessary, it is possible to use some extra additives (one or more) as well as the additional cementation agents 27 in the cementation operation 48, 104, 207, 309. Such may be, for example, potassium antimony tartrate. An amount of substance of zinc 32, as a cementation agent 47, is at least 3 times of an amount of substance of all heavy metals being present in the leach solution 14 to be processed and also in one or more additional cementation agents 27. Thus, the amount of zinc 32 is calculated on the basis of the amount of substance of all combined metals (including Ni) in such a way, that the amount of substance of zinc 32 is at least 3 times higher or more.

According to one embodiment the amount of zinc 32 may be, for example, 40-70%, more particularly, 45-60% (weight-%) and amount of heavy metal containing cementation agents 38, 39 may be, for example, 30-60% (weight-%) of the total amount of agents 47 used in the cementation operation 48. More particular, the amount of copper sulphate 38 may be, for example, 20-40% (weight-%) and the amount of lead nitrate 39 may be, for example, 5-25%, more particularly, 10-25% (weight-%) of the total amount of agents 47 used in the cementation operation 48. In that case, the amount of copper sulphate 38 may be, for example, 60-85% (weight-%) and the amount of lead nitrate 39 may be, for example, 15-40% (weight-%) of the total amount of the additional cementation agents 27 used in the cementation operation 48.

Before the addition of cementation chemicals 32, 38, 39, the mixing speed of the reactor 64 is set in a proper level (depending from the used equipment). In other words, the leach solution 14 is mixed in the cementation operation 48 and a mixing speed of the leach solution 14 to be cemented is established based on the element 33-37, 71 to be removed in the cementation operation 48 from the solution 14 to be cemented. In addition, the processing temperature of the leach solution 14 in the cementation operation 48, 104, 207, 309 is adjusted to be in the range of 20 to 95° C. More particularly, the temperature ranges applied ins the cementation operation 48, 104, 207, 309 may be, for example, 50-85° C., 60-80° C., 65-75° C. or 50-75° C. One example of very specific temperature range may be 70-75° C. It has been noticed that also cadmium may be removed using this temperature range. The temperature may be adjusted, for example, with either an inbuilt heating system arranged in the reactor 64 mantle, or by means of some other apparatus, if this is seemed to be necessary (not shown). If the leach solution 14 has been led directly to the cementation operation 48, 104, 207, 309 from the leaching stage C, then it is possible to avoid the heating of the leach solution 14 to be purified. The temperature is chosen according to which metals shall be removed from the leach solution 14 and how much of them. After this the mixing speed of the reactor 64 is adjusted to proper level on the basis of that what speed is the most optimal for the element 33-37, 71 that is to be removed.

With the addition apparatuses 23 arranged in connection with the reactor 64 the copper sulphate 38 and lead nitrate 39 are added to the solution 14. First may be added solid copper sulphate 38 and then lead nitrate 39 being in the liquid form. After this a nitrogen atmosphere is again created by means of nitrogen 44 as was done in the dissolution phase C, 206, 305 as well, after which the zinc powder of proper mesh size is added to the reactor 64. As said earlier, the amount of latter depends on what elements is desired to be removed from the leach solution 14. The cementation operation 48, 104, 207, 309 may be performed as a single stage process. In other words, it doesn't need many stages to remove the desired substances from the leach solution 15 to be purified. This also simplifies considerably the implementation of the purification process.

The purification of the leach solution 14 from heavy metals starts straightaway when the zinc powder 32 has been added, after which the pH raises to little under five. The pH-value needs not to be adjusted: it is left to change freely during the reaction. If, for some reason, however, it is wanted to lower the pH value during the purification, it is possible to add some sulfuric acid to the solution to make the needed changes. The reaction is continued to the point in which the analyses confirm that the metal(s) that is/are needed to be removed i.e. cemented from the leach solution 14 to the solid phase, after which the solids are filtered off from the purified liquid 15. The solids 49 include nickel (Ni) elements 33, copper (Cu) elements 34, cadmium (Cd) elements 35, lead (Pb) elements 36, cobalt (Co) elements 37 and mercury (Hg) elements 71. It should be noticed that also nickel can be removed by cementation operation in the same cementation process with the other heavy metals. Thus, the effective removal of nickel doesn't particularly need some other processes, such as, complexation, but only the cementation will be enough. This simplifies the operation. By constant monitoring is also avoided too long reaction time which may cause the redissolution of the unwanted metals 33-37, 71. The processing time of the cementation operation 48, 104, 207, 309 may be in the range of 20 minutes to 2 hours, more particular, 30 minutes to 1 hour, for example. The cementation may still continue during the solids separation stage 311, 66. If deemed necessary, the purification can be done in several different phases as well, depending which kind of features are needed from the purified solution 15.

After cementation stage 309 is performed separation stage 310, performed by the filter press 66, for example. In the separation stage 310 the solid substances 49 including heavy metal elements 33-37, 71 have been separated from the zinc and manganese containing sulfate solution 15′ obtained from the cementation operation 48.

On the basis of the analysis of the sample taken from the purified leach solution 15 the solution will be adjusted on the basis of the analysis on tank 67 (stage 311), where appropriate, of the strength of Mn and Zn (metal contents plus other desired properties) in respect of the level of customer demand, by adding calculated amounts of manganese sulfate and zinc sulfate to reach the desired metal levels in connection with the inside storage tanks 67 being in the site close of the reactor 64. It is also possible to add other elements/additives to the solution as well if this is desired by the customer. Also, the pH of the purified solution 15 is determined and adjusted, if necessary (stage 311). The purity of the solution 15 will be analyzed and returned to clean-up, if necessary. When the level of the solution 15 is secured, it shall pass to the IBC containers or the larger storage tank 68 outside, for example, waiting for the packing or the delivery to the distributor for bottling or delivering to the customer.

Owing to the adjustment of pH one or more products 17 can be made of the leach solution 14. This may be done in further processing step E, 105 presented in FIG. 1 and may include stages 311, for example, presented in FIG. 3. These are the products of manganese- and zinc-containing sulphate solution 17, 17′, 17″. According to one embodiment the final product may be applied in the liquid form. This also simplifies the implementation of the process because any kind of precipitation stages, and also the need for chemicals for that have been avoided in the present invention in the preparation of final product 17. These solutions 17, 17′, 17″ are suitable for use as micronutrients alone, in fertilizers and/or together with a plant protective agent, for example. The skilled person understands that the “product” meant in this connection may also be a raw-material for some special final product suitable for some specific purpose in the form of, for example, fertilizer. Sulphate product may also be upgraded to chelate product, for example,

FIG. 4 shows a basic principle of the process and a system according to the invention in a simplified process chart. The components/functions of the system have been presented in the sequential order.

A, B) Pre-processing: feeding of alkaline black mass BM, feeding of air 92, indirectly heated rotary kiln furnace or reel oven 20, cyclone 52 to remove gases from heat treated alkaline black mass 56, gas scrubber 53 (or corresponding flue gas treatment with a proper purification apparatus), cooling conveyor 54 with cooling water inlet and outlet 55.1, 55.2, storage 21 of pre-processed alkaline black mass 56, screening 57.1, 57.2 of pre-processed alkaline black mass 56 with outlets for undersize (fine) and oversize (coarse) alkaline black mass 56.1, 56.2 and a cyclone 93′ and a crusher 75 between the screenings 57.1, 57.2.

C) Leaching process: storage 59 of pre-processed alkaline black mass 56, feeding silo 60, conveyer 18, inlet 61 of water 94 with citric acid 13 and leaching tanks 62 with mixer. Separation and filtration i.e. the pre-processing of leach solution 14′ before removing of one or more elements from the leach solution 14: separation (stage 307; FIG. 3): decanter separator 63 (with overflow gravity), filtration (stage 308). In general, instead of decanter separator 63 can also be speak of solid-liquid separation.

Neutralised, i.e. pH adjusted and clarified manganese- and zinc-containing solution (MnSO₄ and ZnSO₄) can be stored in liquid form. According to one embodiment, the solution can optionally be precipitated as metal hydroxides by altering pH to higher level or crystallized as metal sulphate by evaporating by vacuum assisted heating. Solid hydroxide and/or sulphate products can then be packed in plastic bags. In liquid form content of manganese may be 100-60 g and zinc 100-50 g/one liter. pH of the solution can also be optionally elevated in which case Zn and Mn precipitate in OH form.

The manganese- and zinc-containing sulphate solution 17, 17′, 17″ is to be utilized as micronutrients alone, in fertilizers and/or used together with a plant protective agent to aid growth and health of plants. Amount of zinc in the purified leach solution 15 may be, for example, 50-100 g/liter, more specifically 60-90 g/liter. The solution 17, 17′, 17″ may be mixed with plant-protective agent and spread to the field with that, for example. Owing to that the farmer can avoid one extra work stage. The suitable amount of the solution 17, 17′, 17″ in agriculture may be 2 to 5 liter per hectare, for example.

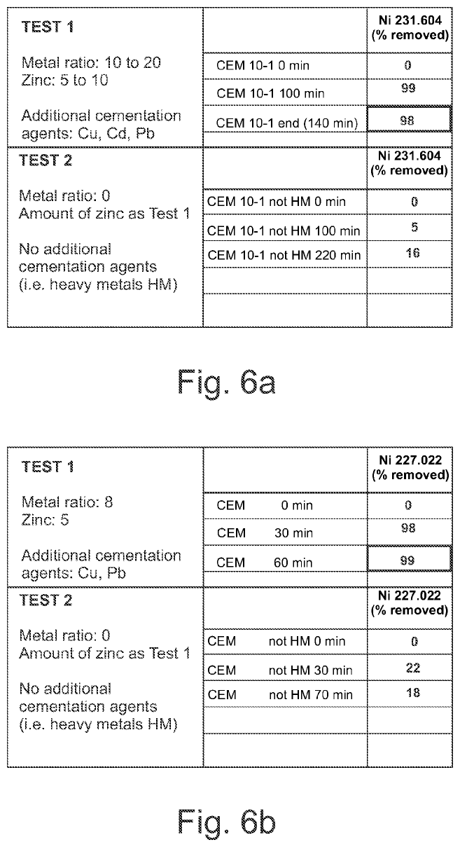

FIG. 6a shows a table of test results comparing the process according to the invention and the process according to the prior art in the case of removal of nickel. Time series of the test have been presented in the table. In Test 1 has been used, in addition to zinc 32 as a cementation agent 47, also copper, cadmium (CdSO₄) and lead elements as additional cementation agents 27. In Test 2 only zinc 32 has been applied as a cementation agent 47. In the case of nickel present in the test solutions can be observed that the process according to the invention is very effective and fast i.e. it removes nickel very fast when compared to the cementation performed using only zinc 32 as a cementation agent 47. If the reaction time of test 2 would be doubled it does not proceed practically at all without the aid of additional cementation agents 27. FIG. 6b shows another test. In that cadmium (CdSO₄) was left out from the additional cementation agents 27. However, despite of that the invention still works very well and only copper (in the form of copper sulphate) and lead (in the form of lead nitrate) are even enough to get the desired purification effect to the leach solution intended to be purified of heavy metal substances 49.

In other words, the purification D of the leach solution 14 of the alkaline black mass i.e. cementation 104 may be proceeded as its own independent process that is not tied to the leaching process C or to the further processing E of the purified leach solution 15 of the black mass of spent alkaline black mass 56. In other words, between the leaching process C of the pre-processed alkaline black mass 56 and the purification D of the leach solution 14 of the pre-processed alkaline black mass 56 and also between the purification D and the further processing E of the purified leach solution 15 may be a delay i.e. those stages need not to be a one continuous stage-by-stage process performed in one site. This also means that the purification D of the leach solution 14 may be performed at another site than the leaching process C and further processing E performed after the purification D and there may be, for example, transportation of the purified leach solution 15 from the purifying site to the further processing site, as well as, from the leaching site to the purifying site.

An example of a system for processing, for example, alkaline black mass BM of spent alkaline batteries has been presented in FIG. 5. The system includes possible pre-processing means of the alkaline black mass BM to pre-process alkaline black mass BM in a pre-processing stage B, leaching means 62 to leach the pre-processed alkaline black mass 56 with one or more acidic solutions 12, 13, 25, 26 in order to produce a leach solution 14 in leaching process C, cementation means 48 (reactor 64) to remove one or more heavy metals 33-37, 71 from the solution 14 of leached alkaline black mass 56 with one or more cementation agents 47 in order to produce a purified leach solution 15 in purifying process D and possible further processing means 66, 67 to produce one or more products 17 from the purified leach solution 15 in possible further processing E. The optional pre-processing means may include one or more crushing means 75, one or more screening and/or magnetic separation means 57.1, 57.2, 69.1, 69.2, 65.1, 65.2, and a heat treatment device 51 or washing means of alkaline black mass BM described earlier in this application and applied in the optional pre-processing stage A before the screening 57.1, 57.2 and magnetic separation 65.1, 65.2.

The implementation of the system concerning leaching and also removing of heavy metals 33-37, 71 from the leach solution 14 by cementation operation 48 may be carried out by means of suitable tanks and/or reactors 62, 64, pumps and pipelines between the tanks and/or reactors 62, 64 arranged in a principle presented in FIG. 1 and also in FIGS. 4 and 5. The different stages of the process A-E may be controlled by the control means 11 (FIG. 5).

The object of the invention is also a product 17, 17′, 17″ of manganese- and zinc-containing sulphate solution which is suitable for use as micronutrients alone, in fertilizers and/or together with a plant protective agent and obtainable by any of processes presented above. As such, the product 17, 17′, 17″ may be applied with a plant-protective agent and/or diluted to water, for example.

The leach solution 14 of the alkaline black mass to be processed is a multi-metal solution. The multi-metal solution include one or more metals of which one or more is intended to be leave to the solution 15 after the cementation operation 48. In addition, the multi-metal solution also includes one or more heavy metals, such as, for example, nickel and copper. The elements 49 to be removed from the solution 14 include or are one or more of the heavy metals being present in the multi-metal solution. The additional cementation agent(s) 27, 38, 39 improves particularly the removal of the selected elements 49 in the case of multi-metal solution.

1-29. (canceled)

30. A process for processing a leach solution of black mass of spent alkaline batteries which leach solution comprises metals dissolved to an acidic solution, the process comprising:
removing of one or more elements from the leach solution by a cementation operation, the cementation operation including applying at least one non-noble metal in a metal form as a cementation agent and one or more additional cementation agents from both sulphate and nitrate groups to process the leach solution into a product of at least manganese- and zinc-containing sulphate solution which is suitable for use as micronutrients alone, in fertilizers and/or together with a plant protective agent to aid growth and health of plants.

31. The process according to claim 30, wherein the processed leach solution is a multi-metal solution comprising:
one or more metals selected from a group which comprises zinc, manganese and potassium; and
one or more heavy metals selected from the group which comprises nickel and copper; and
wherein the removing step includes removing from the leach solution by the cementation operation one or more of the heavy metals comprising the nickel.

32. The process according to claim 30, wherein the one or more additional cementation agents comprise one or more elements comprising heavy metals.

33. The process according to claim 30, wherein the one or more additional cementation agents comprise heavy metals comprising copper in a form of copper sulphate and lead in a form of lead nitrate.

34. The process according to claim 33, wherein total amounts of a substance of copper sulphate and lead nitrate is 2-8 times an amount of substance of nickel being present in the leach solution to be processed.

35. The process according to claim 30, wherein an amount of substance of the non-noble metal in metal form is at least 3 times an amount of substance of all heavy metals being present in the leach solution to be processed and in one or more additional cementation agents.

36. The process according to claim 30, including using a processing temperature of the cementation operation in a range of 20 to 95° C. and using a processing time of the cementation operation in a range of 20 minutes to 2 hours.

37. The process according to claim 30, including using in the cementation operation an amount of at least one non-noble metal in a metal form in a range of 40-70% (weight-%) and an amount of additional cementation agents in a range of 30-60% (weight-%) of a total amount of agents used in the cementation operation.

38. The process according to claim 33, including using an amount of copper sulphate in a range of 20-40% (weight-%) and an amount of lead nitrate in a range of 5-25% (weight-%) of the total amount of cementation agents used in the cementation operation.

39. The process according to claim 33, including using an amount of copper sulphate in a range of 60-85% (weight-%) and an amount of lead nitrate in a range of 15-40% (weight-%) of the total amount of the additional cementation agents used in the cementation operation.

40. The process according to claim 30, comprising implementing the cementation operation as a single stage process.

41. The process according to claim 30, including, before the cementation operation, adjusting a pH of the leach solution with solid substances and, after the adjusting, separating the solid substances from the leach solution before the cementation operation of the leach solution.

42. The process according to claim 30, including using a joint collection of different types of spent batteries to originate the black mass.

43. The process according to claim 30, including using zinc as the at least one non-noble metal in a metal form as a cementation agent.

44. A product of a manganese- and zinc-containing sulphate solution produced according to the process of claim 30, wherein the process further includes removing one or more harmful heavy metals to an acceptable level in which the content of the harmful heavy metals is below limits required for the product to be accepted as a fertilizer product and which product is suitable for micronutrients in fertilizers to aid growth and health of plants.

45. A process for processing a black mass of spent alkaline batteries, comprising:
selectively pre-processing the alkaline black mass, including at least one of heat treating, crushing, magnetically separating ferrous metals, washing to removing non-metallic coarse materials and grinding an already heat treated black mass;
leaching the selectively pre-processed alkaline black mass in an acidic solution to produce a leach solution; and
removing from the leach solution one or more heavy metals by a cementation operation by applying at least one non-noble metal in a metal form and one or more additional cementation agents from both sulphate and nitrate groups as cementation agents to process the leach solution into one or more products of at least manganese- and zinc-containing sulphate solution which is suitable for use as micronutrients alone, in fertilizers and/or together with a plant protective agent.

46. The process according to claim 45, wherein the selective pre-processing of the alkaline black mass comprises removing magnetic metal fraction from the alkaline black mass to be leached to reduce the amount of substance of elements to be removed from the leach solution in the cementation operation.

47. The process according to claim 45, comprising leaching the selectively pre-processed alkaline black mass in a single leaching stage in the presence of at least one strong leaching acid comprising sulfuric acid, at least one reducing leaching agent and water.

48. The process according to claim 45, wherein the leaching step includes leaching in two leaching stages, comprising:
leaching in a first stage the alkaline black mass in the presence of at least one strong leaching acid comprising sulfuric acid to produce a zinc rich leach product; and
leaching in a second stage residual solid substances from the first stage in the presence of at least one strong leaching acid comprising sulfuric acid and at least one reducing leaching agent to produce a manganese rich leach product.

49. The process according to claim 45, comprising, in a beginning period of the leaching:
leaching the selectively pre-processed alkaline black mass using only a portion of an intended total amount of water to form a solution comprising potassium content substances from the alkaline black mass;
removing a portion of the formed solution from the leaching to lower potassium content of the leach solution and to raise the zinc and manganese content of the leach solution and to create a potassium-rich side product of the solution removed from the leaching; and
adding an intended total amount of water to the leaching to proceed the leaching to the end.

50. The process according to claim 45, including maintaining an average particle size of alkaline black mass to be fed to the leaching process to less than 3 mm.

51. A method to aid growth and health of plants, comprising: utilizing the product produced by the process according to claim 30 as micronutrients alone, in fertilizers and/or together with a plant protective agent to aid growth and health of plants.
